(19) United States
(12) Patent Application Publication
(10) Pub. No.: US 2025/0116090 A1
(43) Pub. Date: Apr. 10, 2025

(54) SCARIFIER ASSEMBLY

(71) Applicant: SC Grade, LLC, Maple Grove, MN (US)

(72) Inventor: Bo Jason Stocks, Dixon, WY (US)

(21) Appl. No.: 17/473,489

(22) PCT Filed: Mar. 12, 2020
(86) PCT No.: PCT/US2020/022348

§ 371 Date: Sep. 13, 2021

Related U.S. Application Data
(63) Continuation-in-part of application No. 16/353,232, filed on Mar. 14, 2019, now abandoned.

(51) Int. Cl. E02F 3/76; E02F 3/815

(52) U.S. Cl. CPC E02F 3/7627; E02F 3/7604; E02F 3/8152

(57) ABSTRACT

A scarifier assembly for connection to a vehicle, including right and left first and second pivots. The scarifier assembly has a pivotal arm assembly having a rear cross member extending between and connected to forward extending right and left ends. The forward extending right and left ends are pivotally connected to the respective right and left first pivots. A plurality of teeth is connected to the rear cross member. A right lift actuator is pivotally connected to the right second pivot and pivotally connected to the forward extending right end of the pivotal arm assembly, and a left lift actuator is pivotally connected to the left second pivot and pivotally connected to the forward extending left end of the pivotal arm assembly.

### BACKGROUND

### Cross-Reference to Related Application

This application claims the benefit of U.S. patent application Ser. No. 16/353,232 filed Mar. 14, 2019, which is hereby incorporated herein by reference.

### Field of the Invention

The present invention generally relates to earth moving equipment, and more particularly to a scarifier assembly that may be connected to a vehicle to assist in preparing a ground surface for grading.

### Description of the Related Art

Earth moving equipment is available in different forms and for different purposes. Once excavation and concrete contractors have completed major work, which may include excavating and/or pouring a foundation for a structure, such as a commercial building or house, a dirt contractor works to build up or cut down the dirt pad or ground on the site, which may include the area around and inside of a structure. The dirt contractor is tasked with bringing the site to within 1/10 of a foot of the specifications on a grading site plan. Following the work by a dirt contractor, a fine grading contractor is brought in to move dirt and/or gravel with a goal in fine grading to achieve the highest quality slab and to keep the waste factor as little as possible.

There are times when a fine grading contractor may encounter areas of hard or solid ground, which may include highly compacted soil, frozen portions, concrete or asphalt debris, rocks or other matter. Such areas often require digging and removal by use of heavy duty digging equipment, followed by delivery of new soil to fill as needed because known grading systems typically are not capable of dealing with such solid ground variations or large chunks of hard dirt that may have been left by a dirt contractor. Fine grading systems generally are not equipped to deal with cutting such hard ground environments.

Scarifier equipment may be used in such efforts, as well as in other settings to breakup compacted soil or tear up vegetation, such as when working on landscaping projects. The scarifiers of the scale discussed and disclosed herein are not merely used to dethatch a lawn, but rather are on a larger, more robust scale and are used for more course disruption of a ground surface. Presently available scarifier assemblies or other existing earth moving equipment and systems include disadvantages that limit grading performance and do not enable a fine grading assembly to work through hard ground without extensive intervention from other equipment.

Prior art scarifiers for such larger scale projects tend to be presented as an implement that is mounted to the front or rear of an earth moving vehicle, with the implement extending well forward or rearward of the vehicle. The substantial forward or rearward extension of the implement decreases the maneuverability of the vehicle and may negatively impact the approach and departure angles of the vehicle. This can impose limitations on the vehicle when a prior art implement is connected to thereto, which can be due to the extent to which the implement extends forward or rearward from the vehicle, or the use of further forward or rearward support wheels and/or the mounting and controls associated with such implements. This tends to cause such an implement to have to remain detached from the vehicle unless and until it is ready for specific use on a ground surface that has been prepared to at least a minimum standard. Unfortunately, such an implement likely must remain connected to the vehicle for convenience. In some instances, the implement is connected using the main front mounting for an accessory that is available on a vehicle, such as a skid steer, which means that the vehicle then must be dedicated for that use until the implement is disconnected and some other implement, such as a shovel or blade is connected to the vehicle. Switching implements requires labor and time, which increases risks of injury while reducing productivity due to a machine downtime.

It would be particularly advantageous to be able to use a scarifier assembly on earth moving vehicles, especially multi-use vehicles associated with grading, such as a typical skid steer or other vehicles. It also would be advantageous to be able to have such a scarifier assembly remain connected to such vehicles while being useful for other purposes and while not having to be connected to the main front functional equipment on such vehicles.

### SUMMARY

The present disclosure provides a scarifier assembly for use in a grading system that permits an earth moving vehicle, such as a track or wheeled vehicle to overcome shortcomings in the prior art, while providing major advantages. First, the scarifier assembly of the present disclosure may be connected to a vehicle at an end opposed to the normal working end of the vehicle, such as for example, connection to a rear of a skid steer vehicle that has a typical front mounting system for various implements, such as a shovel or blade or any number of other implements. Second, the new scarifier assembly presents a relatively mass efficient, compact structure that remains close to the vehicle at all times, may be mounted in place of ballast plates, and does not substantially increase the area occupied by the vehicle, thereby having little if any impact on the maneuverability of the vehicle. Third, the scarifier assembly is retractable to a raised position when not in use that is well above the ground surface and it does not present an issue for angles of approach for the vehicle. Fourth, the scarifier assembly may provide for simple adjustment and use by an operator who can readily adjust the depth to which the scarifier assembly will effectively dig through the soil by adjusting the angle of the forward extending arms of the pivotal arm assembly and in some versions by manipulating the set-up of adjustable, removable and easily replaceable teeth. Fifth, in some versions, adjustable, removable teeth may be reversed end-to-end to extend the life of the teeth, and may be rotated to reverse the angle on the end of the teeth to vary the tendency to dig or create furrows, while in other versions a set of teeth may be connected to each other and replaced simultaneously. Sixth, the scarifier assembly may be connected to a vehicle in a way that utilizes the standard auxiliary hydraulic ports provided on the vehicle, or alternatively may be connected to a diverter valve to permit use of two hydraulic functions, by leaving the standard auxiliary hydraulic ports on the vehicle available for other use.

The present scarifier assembly extends a much shorter distance from the vehicle, eliminates the need for additional support wheels and does not occupy the quick attach assembly of a vehicle. The mounting configuration provides for connecting the scarifier assembly to a vehicle that need not include a quick attach assembly. References to directions herein, such as rearward or forward, are relative to the direction of travel when using the scarifier assembly, which may not be the same as the normal directional orientation of a particular vehicle. However, in the examples shown, the scarifier assembly is connected to the rear of a vehicle and is used when the vehicle is moving in the normal forward direction. Advantageously, support for the pivotal arm assembly is provided entirely between the vehicle and the rear cross member.

The scarifier assembly employs simple movement of a pivotal arm assembly by use of lift actuators that move between present full retraction and full extension positions, although it will be appreciated that the range of motion could be less than the full range of motion for the lift actuators. The depth of scoring of the ground is determined by the position of the forward extending arms of the pivotal arm assembly, the length of the teeth, or the adjustment position of if using adjustable, removable teeth. A significant improvement may be provided by having the scarifier assembly connected to a vehicle that also has an operable grading blade assembly on the opposite end of the vehicle. Having both implements available on a track or wheeled vehicle, such as a skid steer, can help to avoid and/or consolidate significant steps that otherwise would follow the work of a dirt contractor. Rather than having to use heavy duty equipment to dig out and remove hard ground, debris or other such matter, and back fill with new soil, use of the new scarifier assembly permits cutting through the aforementioned difficult soil or debris with the same vehicle that is used for fine grading, although it could be used on a separate vehicle that is dedicated to use only of the scarifier assembly. The scarifier assembly can be used to claw or cut through wet soil, helping it to dry faster, while otherwise loosening soil to be more easily redistributed over the ground surface when trying to meet a grading site plan.

The scarifier assembly utilizes compact up and down pivotal movements. Also, the auxiliary hydraulic ports typically available on an earth moving vehicle, such as a skid steer, may be used to operate the scarifier assembly, or the hydraulic system of the vehicle may be modified to include a diverter valve that permits the auxiliary ports to remain available, while providing for separate connection to the scarifier assembly. Because the lift actuators for the pivotal arm assembly of the scarifier assembly readily and quickly lift or lower the respective arms, as desired, the vehicle may rapidly make several passes over the same area, if needed. The efficient, compact structure of the scarifier assembly has a relatively short distance that it extends from the vehicle and it may be used with grading equipment on the opposed end of a vehicle, without need for forward or rearward support wheels, which facilitates greater mobility and permits use of the new scarifier assembly closer to walls or other obstacles.

Although it will be appreciated that the scarifier assembly could be configured differently, it is preferably configured to have the lift actuators operate within a pre-selected range of motion, and further permits the depth of cutting based on the adjustment of removable teeth, if so equipped. The actuators move the pivotal arm assembly to pivot about first pivots and between raised and lowered positions. The assembly additionally is capable of providing substantial downward force to the teeth in a lowered position for cutting or breaking up solid or compacted surfaces and for tilling soil. Ultimately, this permits the vehicle to be used to more quickly and easily achieve the goal of providing a high quality slab, and finishing the fine grading well within the required site plan specifications, while reducing the waste factor. The teeth preferably are spaced relatively closely, such as around six inches apart. This is advantageous in breaking up the soil and other material faster and more completely. However, it will be appreciated that the spacing could be fixed or increased or decreased, and could be altered, such as by having receivers every three inches apart, which would permit separation by increments of three inches by selectively removing teeth. Additionally, different tooth designs, some of which may include hardened tips, may be implemented quite easily, depending on the soil conditions and the tendency for example to need to break up or till the soil.

In a first aspect, the disclosure provides a scarifier assembly for connection to a vehicle, with the scarifier assembly including a right first pivot and second pivot, and a left first pivot and second pivot. A pivotal arm assembly includes a rear cross member extending between and connected to a forward extending right end and a forward extending left end, with a plurality of teeth connected to the rear cross member of the pivotal arm assembly. The forward extending right end of the pivotal arm assembly is pivotally connected to the right first pivot and the forward extending left end of the pivotal arm assembly is pivotally connected to the left first pivot. A right lift actuator is pivotally connected at a first end to the right second pivot and is pivotally connected at a second end to the forward extending right end of the pivotal arm assembly at a location spaced from the connection of the forward extending right end of the pivotal arm assembly to the right first pivot. Similarly, a left lift actuator is pivotally connected at a first end to the left second pivot and is pivotally connected at a second end to the forward extending left end of the pivotal arm assembly at a location spaced from the connection of the forward extending left end of the pivotal arm assembly to the left first pivot.

It is to be understood that both the foregoing general description and the following detailed description are exemplary and provided for purposes of explanation only, and are not restrictive of the subject matter claimed. Further features and objects of the present disclosure will become more fully apparent in the following description of the preferred embodiments and from the appended claims.

### BRIEF DESCRIPTION OF THE DRAWINGS

In describing the preferred embodiments, reference is made to the accompanying drawing figures wherein like parts have like reference numerals, and wherein:

FIG. 1A is a right rear perspective view showing a first example scarifier assembly connected to the rear of a first example vehicle and having a pivotal arm assembly in a first, raised position, with teeth connected to a rear cross member of the pivotal arm assembly by use of a first fastener configuration for connecting removable teeth.

FIG. 1B is a right rear perspective view showing the example vehicle of FIG. A1 presenting a mounting position for a right housing of the scarifier assembly after ballast plates have been removed from the vehicle.

FIG. 1C is a right rear perspective view showing a cross-sectioned portion of a right housing of the scarifier assembly connected to the right rear of the first example vehicle of FIG. 1A.

FIG. 2 is a left rear perspective view of the first example scarifier assembly connected to the vehicle of FIG. 1A and having the pivotal arm assembly moved to a second, lowered position with the removable, adjustable teeth engaging the ground.

FIG. 3 is a right rear perspective view of the first example scarifier assembly connected to the vehicle of FIG. 1A and having the right housing cross-sectioned, while the pivotal arm assembly is moved to show the lift moved to the second, lowered position with the removable, adjustable teeth engaging the ground.

FIG. 4 is a side view of the first example scarifier assembly connected to the vehicle of FIG. 1A and having the pivotal arm assembly moved to the first, raised position.

FIG. 5 is a closer right rear perspective partially exploded view of a portion of the rear of the first example vehicle of FIG. 1A and showing use of an alternative second fastener configuration for connecting the removable teeth, with the teeth from the right side of the pivotal arm assembly removed and stowed on optional storage posts atop the right housing, while the removable teeth and elongated mounting rod of the second fastener configuration for the left side of the pivotal arm assembly are exploded away from the pivotal arm assembly.

FIG. 6 is a top view of a portion of a hydraulic circuit by which the first example scarifier assembly may be hydraulically connected to the first example vehicle of FIG. 1A.

FIG. 7 is a right rear perspective view showing a second example scarifier assembly connected to the rear of a second example vehicle and having a pivotal arm assembly in a first, raised position.

FIG. 8 is a left rear perspective view of the second example scarifier assembly connected to the vehicle of FIG. 7 and having the left housing cross-sectioned, while the pivotal arm assembly is moved to show the lift moved to the second, lowered position with removable, adjustable teeth engaging the ground.

FIG. 9 is a closer right rear perspective partially exploded view of a portion of the rear of the second example vehicle of FIG. 7 and showing some of the removable teeth from the right side of the pivotal arm assembly and a third fastener configuration for the removable teeth exploded away from the pivotal arm assembly.

FIG. 10 is a left rear perspective view of a third example scarifier assembly connected to the vehicle of FIG. 1A and having teeth removably connected to a removable rear cross member of the pivotal arm assembly, which is moved to a second, lowered position.

FIG. 11 is a left rear perspective partially exploded view of the third example scarifier assembly of FIG. 10.

FIG. 12 is a left rear perspective view of a fourth example scarifier assembly connected to the vehicle of FIG. 1A and having teeth connected to a removable rear cross member of the pivotal arm assembly moved to a second, lowered position.

It should be understood that the drawings are not to scale. While some mechanical details of the example scarifier assembly, including details of fastening means and other plan and section views of the particular components, have not been shown, such details are considered to be within the comprehension of those of ordinary skill in the art in light of the present disclosure. It also should be understood that the present disclosure and claims are not limited to the preferred embodiments illustrated.

### DETAILED DESCRIPTION

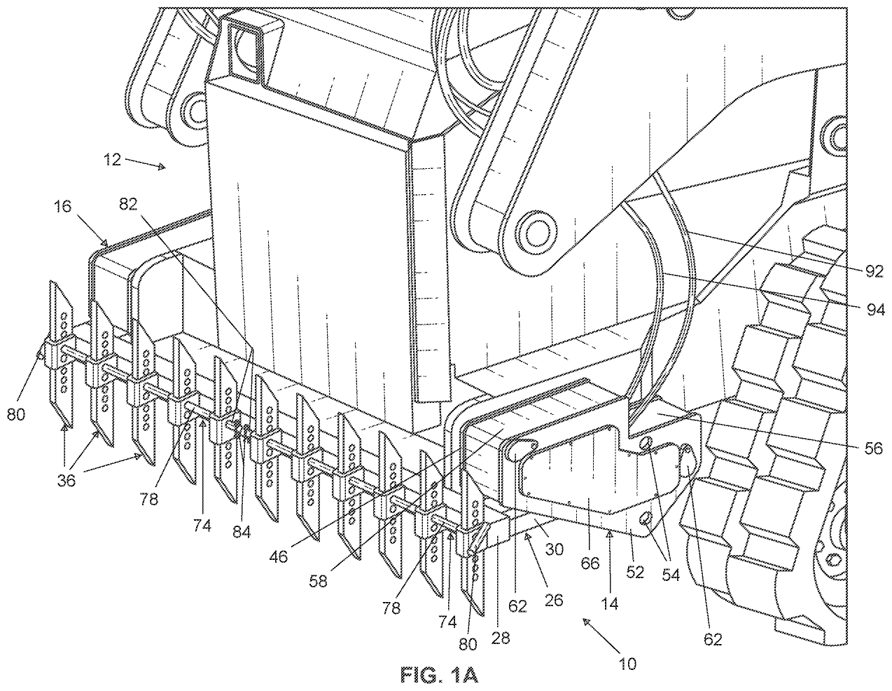

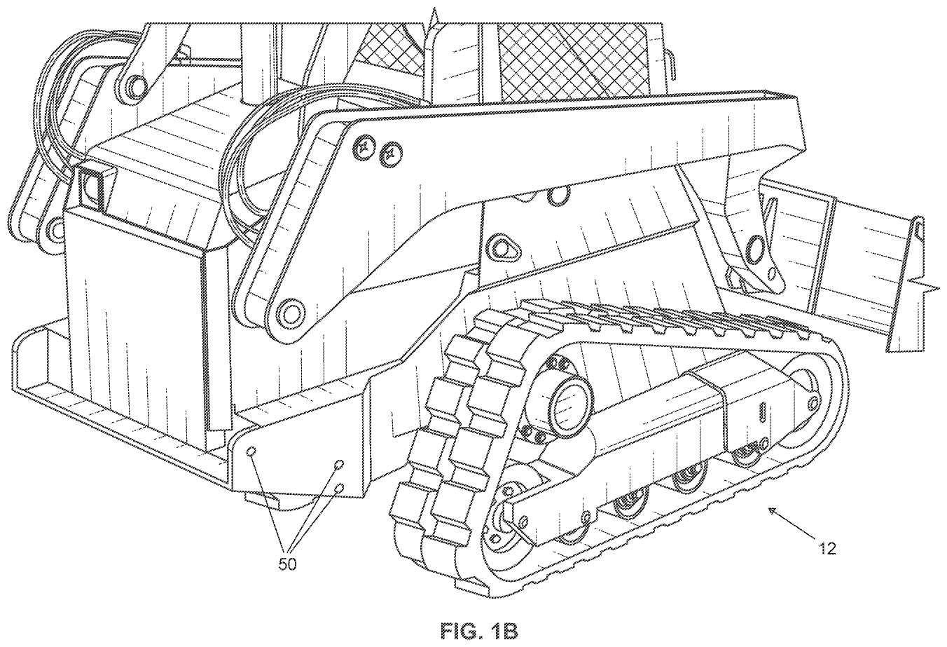

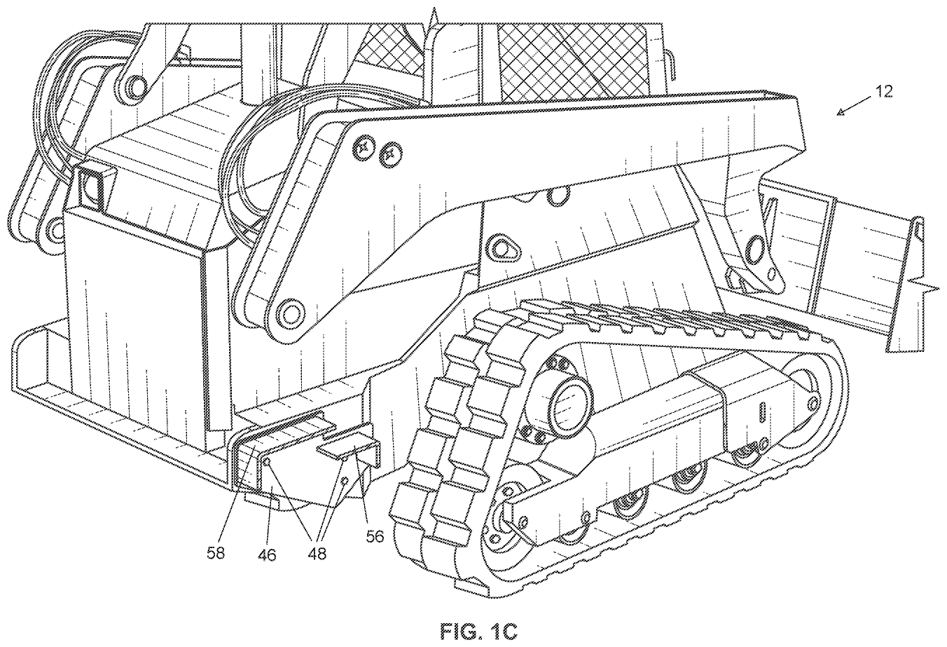

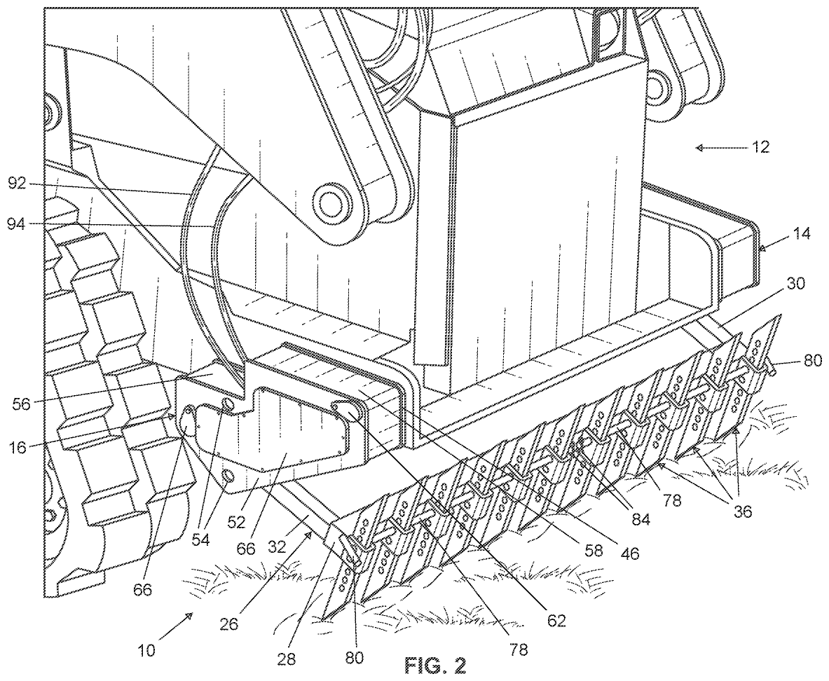

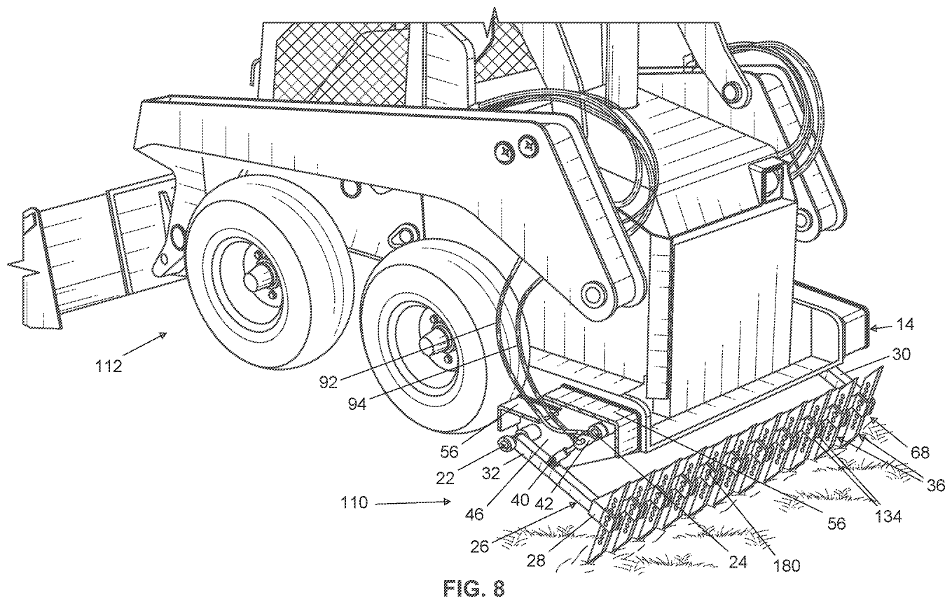

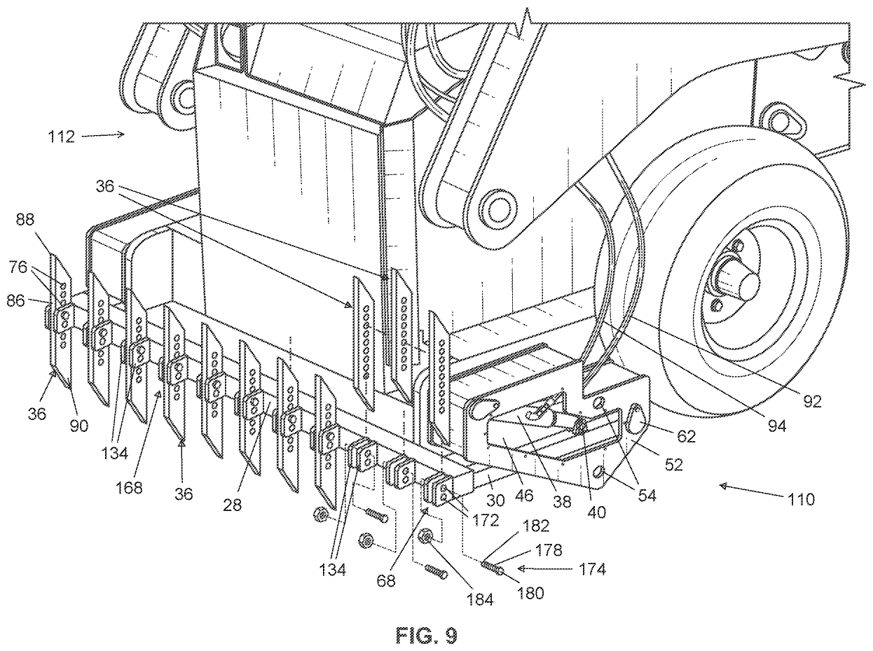

Referring generally to FIGS. 1-12, it will be appreciated that scarifier assemblies of the present disclosure generally may be embodied in numerous configurations. Indeed, the teachings within this disclosure present embodiments that provide significant advantages over prior art scarifier assemblies, and in some instances with optional alternative structures.

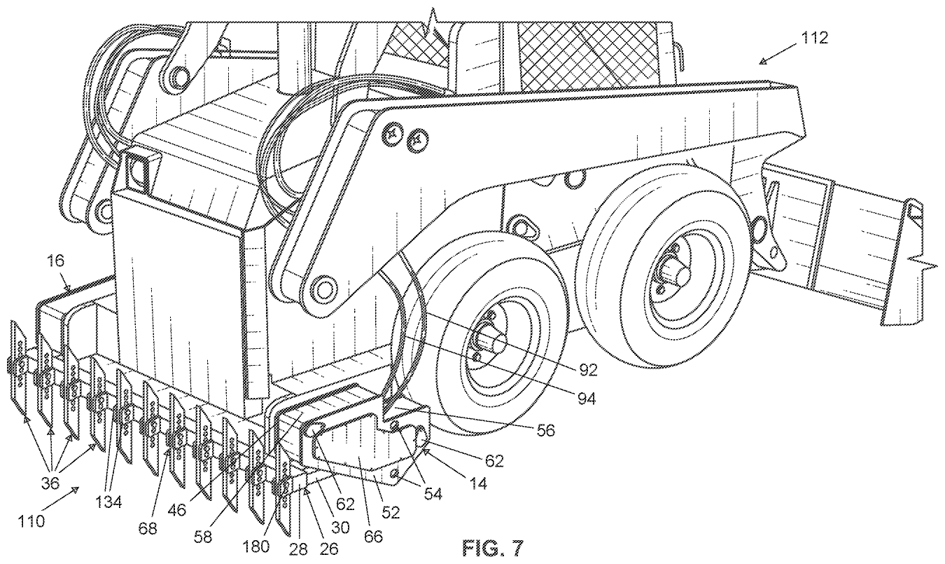

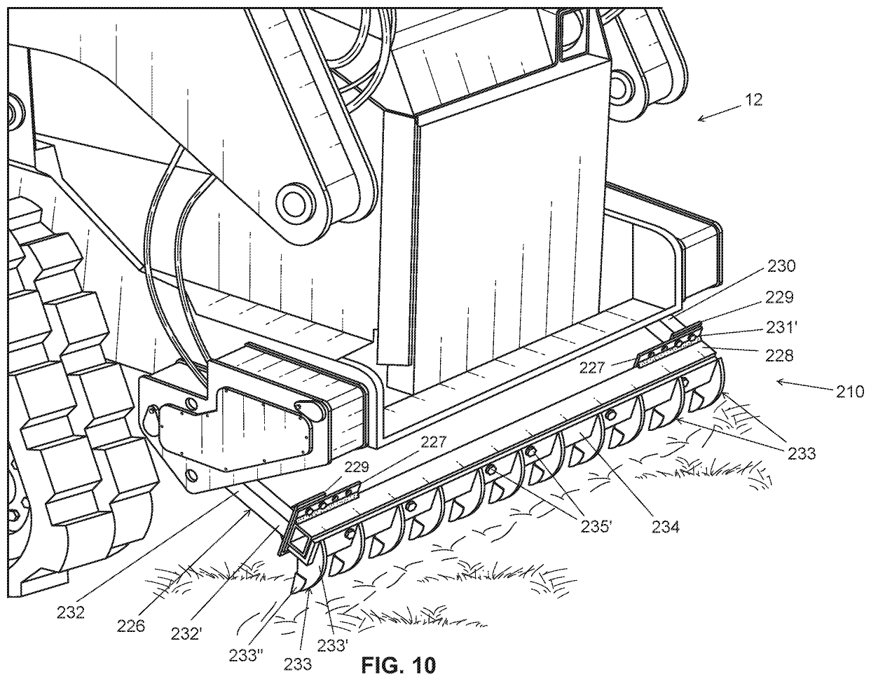

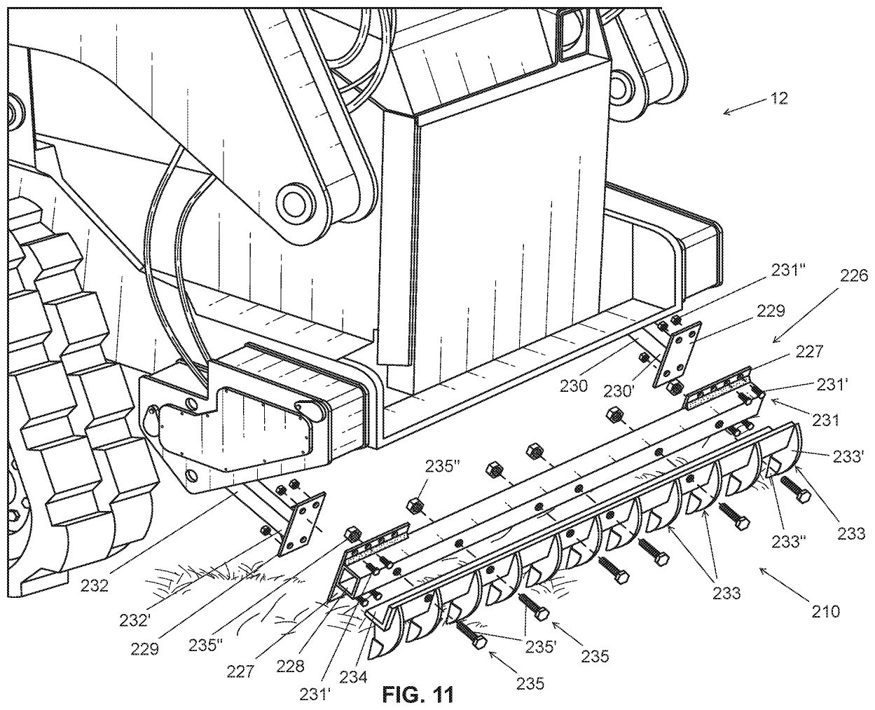

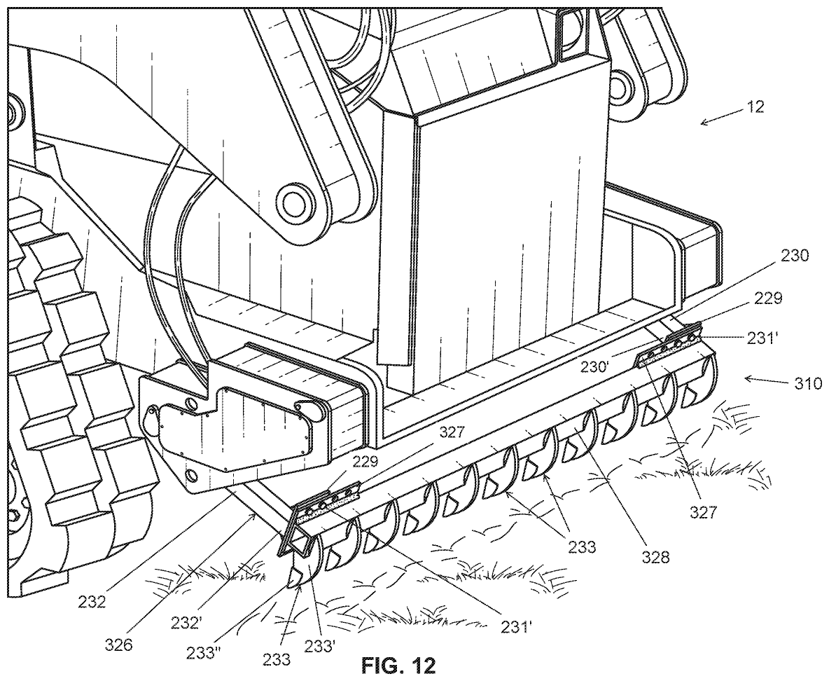

FIGS. 1-6 show a first example scarifier assembly 10 for connection to a first example vehicle 12. It will be appreciated that the first example vehicle 12 is an earth moving vehicle constructed as a track vehicle, such as a skid steer vehicle that may be available from a number of different manufacturers of commercial construction equipment. It will be appreciated that the first scarifier assembly 10 also may be connected to a wheeled vehicle, such as the second example vehicle 112 shown in FIGS. 7-9, to which a second example scarifier assembly 110 is connected. It will be appreciated that, as with the preceding examples, a third example scarifier assembly 210, which is shown in FIGS. 10-11, and a fourth example scarifier assembly 310, which is shown in FIG. 12, are shown attached to the vehicle 12, but either may be connected to a track or wheeled vehicle, as desired.

The scarifier assembly 10 includes a right housing assembly 14 and a left housing assembly 16. The right housing assembly 14 includes a right first pivot 18 and second pivot 20, and the left housing assembly 16 includes a left first pivot 22 and second pivot 24. It will be appreciated that the pivots optionally could be connected directly to the vehicle, in original equipment mountings, without having to be located within housings, but even with direct connection the pivots optionally could be concealed within housings. A pivotal arm assembly 26 is generally U-shaped and includes a rear cross member 28 extending between and connected to a forward extending right end 30 and a forward extending left end 32. The rear cross member 228 and forward extending right and left ends 30, 32 are shown as square tube, such as 3″ steel square tube. However, it will be appreciated that these components could be of different sizes, materials and configurations, such as cylindrical tube, angle iron or other rigid elongated members, whether of unitary construction or removably connected. The pivotal arm assembly 26 further includes a plurality of flanges 34 connected to the rear cross member 28 and a plurality of elongated teeth 36 removably connected to the plurality of flanges 34. The forward extending right end 30 of the pivotal arm assembly 26 is pivotally connected to the right first pivot 18 of the right housing assembly 14 and the forward extending left end 32 of the pivotal arm assembly 26 is pivotally connected to the left first pivot 22 of the left housing assembly 16. A right lift actuator 38 is pivotally connected at a first end to the right second pivot 20 of the right housing assembly 14 and is pivotally connected at a second end to the forward extending right end 30 of the pivotal arm assembly 26 at a location 40 spaced from the connection of the forward extending right end 30 of the pivotal arm assembly 26 to the right first pivot 18 of the right housing assembly 14. A left lift actuator 42 pivotally connected at a first end to the left second pivot 24 of the left housing assembly 16 and pivotally connected at a second end to the forward extending left end 32 of the pivotal arm assembly 26 at a location 44 spaced from the connection of the forward extending left end 32 of the pivotal arm assembly 26 to the left first pivot 22 of the left housing assembly 16.

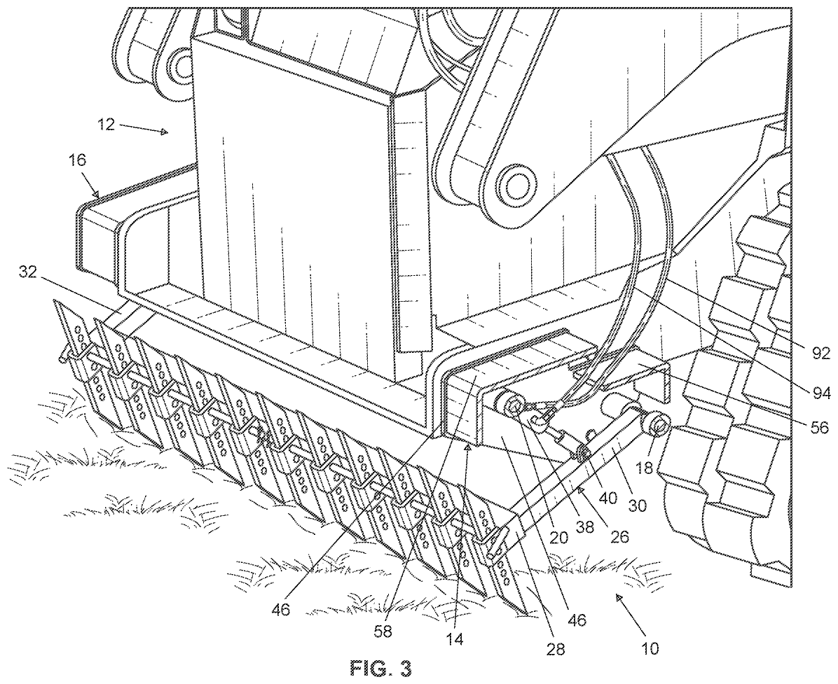

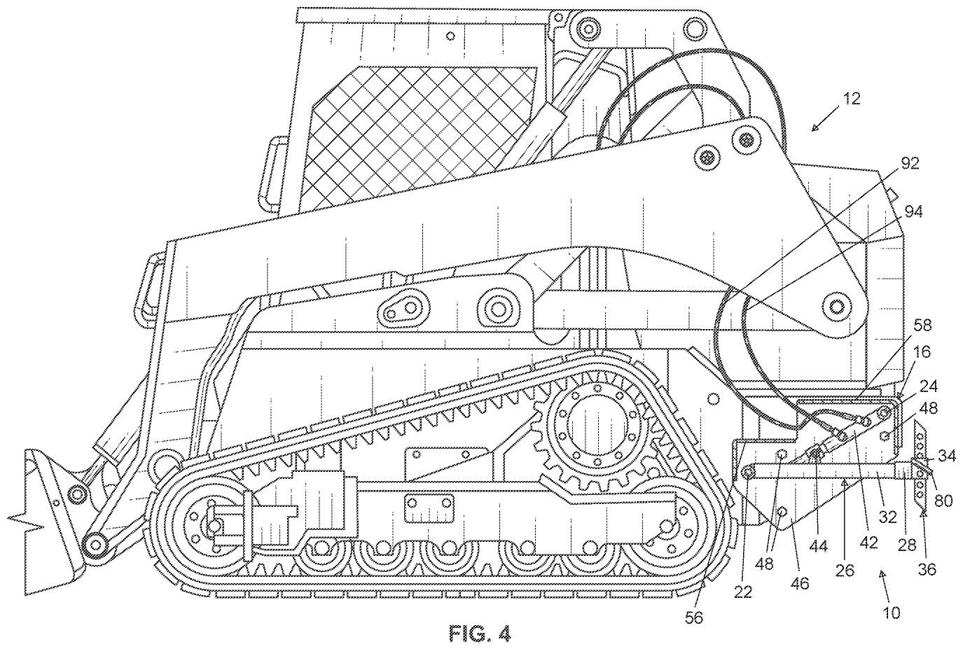

As will be appreciated by viewing FIGS. 3 and 4, for each of the right and left sides of the scarifier assembly 10, the first pivot 18, 22 is forward of and lower than the second pivot 20, 24. With the forward extending right and left ends 30, 32 of the pivotal arm assembly 26 connected to the respective right and left first pivots 18, 22, and the respective lift actuators 38, 42 connected at first ends to the respective right and left second pivots 20, 24 and at second ends to locations spaced from the connection of the pivotal arm assembly to the respective right and left first pivots 18, 22, this results in a configuration wherein the pivotal arm assembly 26 is lowered when extending the lift actuators 38, 42, and raised when retracting the lift actuators 38, 42.

In this example, which utilizes housings, each of the right and left housing assemblies 14, 16 of the scarifier assembly 10 has an inner wall 46 connected to the vehicle 12. For example, as best seen in FIGS. the inner wall 46 of each of the housing assemblies 14, 16 may be connected to the rear of the vehicle 12 via mounting fasteners 48, such as bolts, which are received by threaded mounting holes 50 that are otherwise provided for mounting ballast plates. It will be appreciated that different vehicles may have different locations and mounting holes or other means of fastening, which may be accounted for by varying the configuration of the scarifier assembly 10. Each of the right and left housing assemblies 14, 16 of this example further includes an outer wall 52, and the right and left first pivot 18, 22 and second pivot 20, 24 extend between the respective inner wall 46 and outer wall 52. The outer wall 52 of each of the right and left housing assemblies 14, 16 optionally includes mounting apertures 54 through which mounting fasteners 48 are accessible. The right and left housing assemblies 14, 16 have a forward upper wall 56 and a rearward upper wall 58 that extend between and are connected to the inner wall 46 and outer wall 52, but remain open in the vertical space between the forward upper wall 56 and rearward upper wall 58, as well as across the bottom of the housing assemblies 14. 16.

The outer wall 52 of each of the right and left housing assemblies 14, 16 further include respective apertures 60 through which the first pivot 18, 22 and second pivot 20, 24 are accessible, and further include closure elements 62 that extend over the respective apertures 60. The closure elements 62 are configured as tabs mounted by bolts that can be loosened to pivot the tabs to gain access to the first pivots 18, 22 and second pivots 20, 24 for maintenance, such as lubrication, or removal to permit removal of the pivotal arm assembly 26 and/or lift actuators 38, 42. Each outer wall 52 of the right and left housing assemblies 14, 16 also has a central opening 64 through which the respective lift actuator 38, 42 is accessible. Each central opening 64 is closed by a removable cover 66 to help protect the lift actuators 38, 42 from debris, inadvertent contact or other damage.

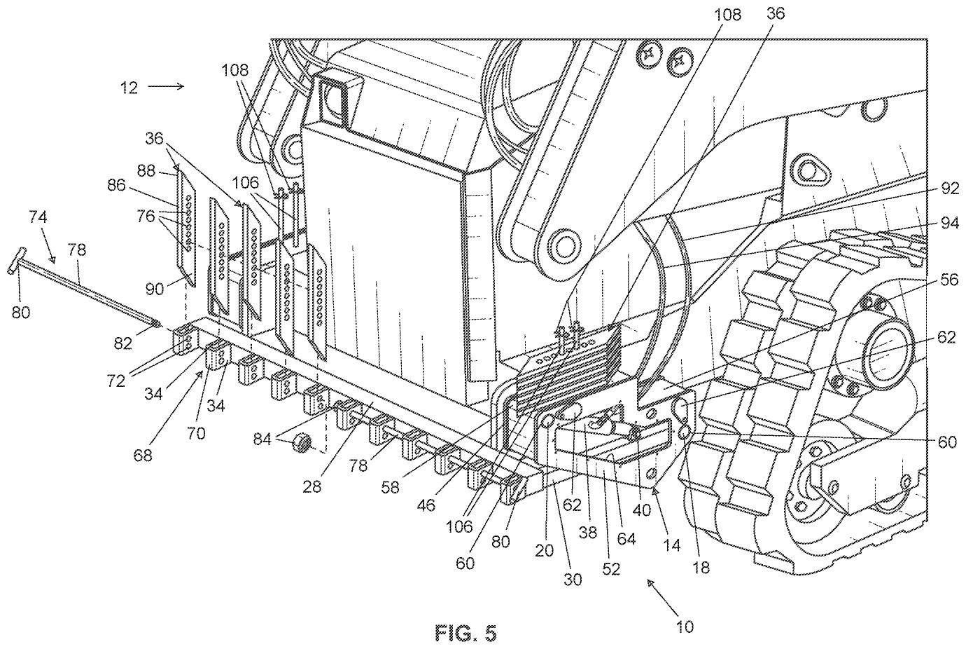

As best seen in FIG. 5, the plurality of flanges 34 connected to the rear cross member 28 of the pivotal arm assembly 26 are arranged in pairs, with each pair of flanges 34 configured as a receiver 68 that receives one of the plurality of teeth 36 between the respective pair of flanges 34. This is one example for connection of a plurality of teeth to a rear cross member, but it will be appreciated that other methods of connection may be employed. In this first example, the receiver 68 is U-shaped and includes a rear wall 70 that connects the pair of flanges 34. To connect one of the plurality of teeth 36 to the flanges 34 of a receiver 68, the plurality of flanges 34 that are connected to the rear cross member 28 include at least one mounting aperture 72 configured to receive a fastener 74 that also extends through an aperture 76 in one of the plurality of teeth 36. To enhance the adjustability of the scarifier assembly 10, the plurality of flanges 34 connected to the rear cross member 28 of this example actually include two mounting apertures 72 at different heights in each of the flanges 34, with each of the two mounting apertures 72 being configured to receive the fastener 74 that extends through the aperture 76 in one of the plurality of teeth 36.

It will be appreciated when viewing FIG. 5 that for at least one of the plurality of teeth 36 of the first example scarifier assembly 10, the fastener 74 that extends through the apertures 72 in the flanges 34 and through the aperture 76 in one of the teeth 36, includes an elongated rod 78. Indeed, in this example, for ease of adjusting the depth of cutting by the teeth 36, the elongated rod 78 extends through respective apertures 72 in two or more flanges 34 and two or more of the plurality of teeth 36. In this manner, as shown in FIGS. 1A and 2-5, the depth of cutting of several teeth 36 may be adjusted in a very simple and quick manner by simply withdrawing the elongated rod 78 from the teeth 36, shifting the vertical position of each tooth 36 relative to the apertures 72 through the flanges 34 and then reinserting the elongated rod 78 through the respective teeth 36.

To help facilitate adjustment of the depth of the teeth 36, a first end 80 of the elongated rod 78 includes a handle for ease of grasping and manipulating, while the opposed second end 82 includes structure to secure the elongated rod 78 in position. For instance, as seen in FIGS. 1A, 2 and 3, the elongated rod 78 may have a hole through the second end 82 and the second end 82 may be secured by use of a clevis pin 84, cotter pin or the like. It will be appreciated that alternative ways of securing the ends of the fastener 74 may be utilized, one of which may be seen in FIG. 5 where the second end 82 is threaded to receive a nut 84, such as a Nyloc® nut, to ensure the elongated rod 78 will not inadvertently be removed or fall from the vehicle 12.

For ease of use, the lift actuators 38, 42 may be configured with an intention to be fully extended to a preset limit when intending to engage a ground surface and fully retracted when intending to otherwise operate the vehicle 12. The lift actuators may be extended or retracted to intermediate positions, but if using presets to full extension and full retraction, in essence, the pivotal arm assembly 26 is lowered to be approximately two inches from the ground surface when the lift actuators 38, 42 are in their fully extended position. Therefore, in such an example using the presets, the depth of cutting of the soil is controlled by adjusting the extent to which the teeth 36 extend downward from the rear cross member 28. As best seen in FIG. 5, to provide for cutting depth adjustment, each of the plurality of teeth 36 includes a central body 86 having a plurality of the apertures 76 along a length of the central body 86. Also, as seen in FIG. 5, if there is a desire to operate the vehicle 12 with the pivotal arm assembly 26 in a raised position, but without the teeth 36 connected thereto, then the teeth 36 may be stowed elsewhere, such as on the optional posts 106 that may be mounted to the top of the rearward upper wall 58 of the right and left housing assemblies 14, 16. Stowing the teeth 36 may help to protect them from damage and they may be retained on the posts 106, such as by use of a clevis pin 108, threaded engagement of the posts 106 with nuts, or use of other suitable fasteners.

To enhance the ability to penetrate and break-up compacted soil or other materials, each of the plurality of teeth 36 further includes an upper end 88 having an upward extending angle from the central body 86 and a lower end 90 having a downward extending angle from the central body 86. As noted in a later example, the teeth also may include a hardened tip. Preferably, the angle at which the upper end 88 extends upward is the same as the angle at which the lower end 90 extends downward, and both are preferably 45 degrees, but it will be appreciated that other angles may be used. The pivotal arm assembly 26 preferably is deployed at an angle of approximately 40 degrees when in the fully lowered position. With this example configuration and each of the teeth 36 having upper and lower ends 88, 90 at angles of 45 degrees, each of the teeth 36 will tend to have a forward tip that is deeper than a heel or trailing portion of the lower end 90. It will be appreciated that the depth of the teeth 36 will tend to influence whether the teeth are rupturing the compacted or hard ground surface or tending to till and create furrows. With apertures 76 being approximately one inch apart, the approximately 40 degree angle of the pivotal arm assembly 26 means that that adjustment from one aperture 76 to the next results in a depth adjustment of roughly one half inch, although it will be appreciated that other configurations may be utilized.

As will be appreciated in FIG. 5, with the upper and lower ends 88, 90 of the teeth 36 cut at similar angles, the orientation of each of the plurality of teeth 36 is reversible end to end to present the same downward extending angle from the central body 86. Thus, each of the teeth 36 may be removed, rotated about a horizontal axis and reconnected to the flanges 34, advantageously doubling the wear life. As a further advantage, each of the plurality of teeth 36 may be rotated to reverse the downward extending angle from the central body 86. Thus, each of the teeth 36 may be removed, rotated about a vertical axis and reconnected to the flanges 34, such as in the position shown in FIG. 4, resulting in less aggressive engagement of the ground surface, such as may be utilized more for tilling the soil.

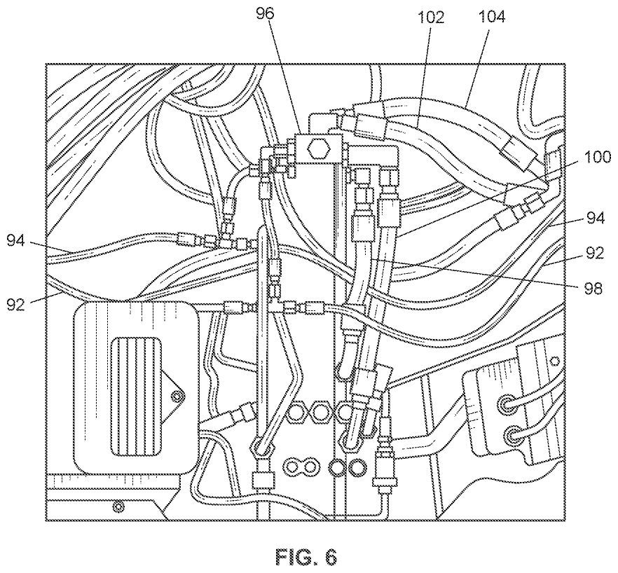

For advantageous compatibility with most earth moving equipment, the lift actuators may be hydraulic actuators, or other suitable actuators. As will be appreciated and best seen in FIGS. 3 and 4, the lift actuators 38, 42 may utilize supply lines 92 and return lines 94, which may be connected to auxiliary ports of a standard hydraulic system on a vehicle, in a conventional manner, such as with respect to auxiliary ports on the front lift arms of a skid steer. The supply lines 92 and return lines 94 for the actuators 38, 42 advantageously alternatively may be connected to the hydraulic system of a vehicle by being connected to a diverter valve 96, such as is shown in FIG. 6. The diverter valve 96 is spliced into the hydraulic system of the vehicle 12 by being connected on a source side coming from the vehicle 12 to a supply line 98 and return line 100. The diverter valve 96 then may be operated by a solenoid that provides an opportunity for an operator to choose function one or function two. In this instance, function one would be to control the hydraulic function at the auxiliary ports of the vehicle by use of a supply line 102 and return line 104, and function two would be to control the lift actuators 38, 42, via supply lines 92 and return lines 94.

FIGS. 7-9 show an alternative vehicle 112, which is a wheeled skid steer, which is employing a scarifier assembly 110 connected at its rear in a similar manner to that shown with the first example scarifier assembly 10 and first example vehicle 12. This second example scarifier assembly 110 largely includes the same components as in the first example scarifier assembly 10, and the previous description applies with respect to like numbered components. The one way in which the scarifier assembly 110 differs from the earlier example scarifier assembly 10 is with respect to having pairs of flanges 134 that are connected to the pivotal arm assembly 26 at a forward end but are not connected to each other at a rearward end, as in the prior example. Each pair of flanges 134 provides a receiver 168 that receives one of the plurality of teeth 36 therebetween. A further alternative way of connecting the teeth 36 is shown in FIGS. 7-9 with respect to the second example vehicle 112. Each of the teeth 36 is connected by use of a fastener 174, which includes a bolt 178 with a first end 180 having a bolt head and a second end 182 being threaded. The threaded second end 182 receives a nut 184, similar to the alternative example shown in FIG. 5. Thus, each bolt 178 extends through apertures 172 in the pair of flanges 134, and through an aperture 76 in one of the teeth 36. It will be appreciated that this provides secure connection of the individual teeth 36, but would require more time to make an adjustment to the depth of the cutting by the teeth 36.

FIGS. 10-11 show a third scarifier assembly 210 connected to the rear of the previously described first example vehicle 12. The scarifier assembly 210 includes a U-shaped pivotal arm assembly 226 that is connected to the vehicle 12 in a manner similar to that already described with respect to the first example scarifier assembly 10 and the via similarly numbered components. The scarifier assembly 210 also may be operated and used in the same manner as described for the first example scarifier assembly. The pivotal arm assembly 226 includes a rear cross member 228 extending between and connected to forward extending right end 230 and forward extending left end 232. As in the previous examples, the rear cross member 228 and forward extending right and left ends 230, 232 are shown as a square tube, such as a 3″ steel square tube. However, it will be appreciated that these components could be of different sizes, materials and configurations, such as cylindrical tube, angle iron or other rigid elongated members, whether of unitary construction or removably connected.

In the third example, the rear cross member 228 includes mounting flanges 227 at respective opposed right and left ends, and the rear end 230′ of the forward extending right end 230 and rear end 232′ of the forward extending left end 232 of the pivotal arm assembly 226 each comprises a mounting flange 229, respectively. The mounting flanges 227 at the opposed right and left ends of the rear cross member 228 are removably connected to mounting flanges 229 at the respective rear ends of the forward extending right end 230 and forward extending left end 232 of the pivotal arm assembly 226. The rear ends of the forward extending right end 230 and left end 232 are connected to the rear cross member 228 via fasteners 231. As may be seen in FIGS. 10 and 11, the fasteners 231 include bolts 231′ and nuts 231″ that are threadably connected to the bolts 231′. The wider mounting flanges 227 at the opposed ends of the rear cross member 228 include a series of spaced apertures that are configured to be aligned with apertures in mounting flanges 229 at the rear ends 230′, 232′ of forward extending ends 230, 232 and to accommodate narrower or wider vehicles. Thus, a common rear cross member 228 may be used on vehicles having a variety of widths, and the connection via the respective mounting flanges 227, 229 and fasteners 231 advantageously enables the pivotal arm assembly 228 of the scarifier assembly 210 to be more easily and efficiently packaged and shipped.

It will be appreciated that connection of a rear cross member to the right and left forward extending ends on vehicles having different widths alternatively may be accomplished using different mounting flange and fastener configurations. For example, the difference in the widths of the respective mounting flanges 227 and mounting flanges 229 may be reversed, so that wider mounting flanges are at the rear ends of the forward extending ends of the pivotal arm assembly, and they may be configured to accept one or more widths for a rear cross member. In another example, the mounting flanges at the rear ends 230′, 232′ of the forward extending ends 230, 232 of the pivotal arm assembly may be used without using mounting flanges on the rear cross member and standard nuts and bolts. Instead, U-shaped bolts and nuts may be used to connect the rear cross member to the mounting flanges 229 at the rear ends 230′, 232′ of the forward extending ends 230, 232.

The third example scarifier assembly 210 also illustrates that teeth may be of a different configuration and may be connected to the rear cross member in further different ways. For example, each elongated tooth 233 may include a body portion 233′ constructed of ½″ thick AR50 plate steel or other suitable material. A hardened tooth tip 233″ optionally may be connected to the body portion 233′ of the tooth 233. The hardened tooth tip 233″ may, for example, be a weld-on DT50 hardened tooth tip offered by Kennametal Inc., which may be welded to the tooth body portion 233′ to improve the durability of the teeth 233. In turn, alternative configurations may be used for connection of the teeth 233 to the rear cross member 228, such as may be seen in FIGS. 10-11. The teeth 233 are removably connected to the rear cross member 228 by being connected to an elongated element 234 that is removably connected to the rear cross member 228. For example, a plurality of teeth 233 may be welded to one or more elongated elements 234 in the form of angle iron, such as a ⅜″ thick, 3″×3″ solid steel angle. The one or more elongated elements 234 may be removably connected to the rear cross member 228 by use of fasteners 235. As may be seen in FIGS. 10 and 11, the fasteners 235 pass through aligned apertures in the rear cross member 228 and apertures in the elongated element 234. The fasteners 235 may include bolts 235′ and nuts 235″ that are threadably connected to the bolts 235′, or other suitable fasteners. It will be appreciated that one or more elongated members 234 may be connected to the rear cross member 228 in other ways. For example, U-shaped bolts and nuts may be used to connect an elongated element 234 to a rear cross member 228, or to simultaneously and connect both the rear cross member 228 and the elongated element 234 to the mounting flanges 229 at the rear ends 230′, 232′ of the forward extending ends 230, 232.

As noted previously, the forward portion of the pivotal arm assembly 226 of the third example scarifier assembly 210 may be connected to a vehicle and operate in a similar manner to the previous example scarifier assemblies 10 and 110. Thus, the forward extending right end 230 of the pivotal arm assembly 226 is pivotally connected to a right first pivot and the forward extending left end 232 of the pivotal arm assembly 226 is pivotally connected to a left first pivot. Accordingly, a right lift actuator is pivotally connected at a first end to a right second pivot and is pivotally connected at a second end to the forward extending right end 230 of the pivotal arm assembly 226 at a location spaced from the connection of the forward extending right end 230 of the pivotal arm assembly 226 to the right first pivot. Similarly, a left lift actuator is pivotally connected at a first end to the left second pivot and pivotally connected at a second end to the forward extending left end 232 of the pivotal arm assembly 226 at a location spaced from the connection of the forward extending left end 232 of the pivotal arm assembly 226 to the left first pivot. As noted, the pivots may be directly connected to a vehicle or may be connected via housing assemblies, as shown for the first example scarifier assembly 10.

FIG. 12 shows a fourth scarifier assembly 310 connected to the rear of the previously described first example vehicle 12. The scarifier assembly 310 includes a U-shaped pivotal arm assembly 326 that is connected to the vehicle 12 in a manner similar to that already described with respect to the previous example scarifier assemblies 10, 110 and 210, and the via similarly numbered components. The scarifier assembly 310 also may be operated and used in the same manner as described for the previous example scarifier assemblies.

The scarifier assembly 310 is most similar to the scarifier assembly 210 of the third example, including similar teeth 233, but differs with respect to how the teeth 233 are connected to a rear cross member 328. The pivotal arm assembly 326 includes a rear cross member 328 extending between and connected to forward extending right end 230 and forward extending left end 232. As in the previous examples, the rear cross member 328 and forward extending right and left ends 230, 232 are shown as square tube, such as a 3″ steel square tube. However, it will be appreciated that these components could be of different sizes, materials and configurations, such cylindrical tube, angle iron or other rigid elongated members, whether of unitary construction or removably connected.

In the fourth example, the rear cross member 328 is similar to the rear cross member 228 in that it includes mounting flanges 327 at respective opposed right and left ends, and the rear end 230′ of the forward extending right end 230 and rear end 232′ of the forward extending left end 232 of the pivotal arm assembly 326 each comprises a mounting flange 229, respectively. The mounting flanges 327 at the opposed right and left ends of the rear cross member 328 are removably connected to mounting flanges 229 at the respective rear ends of the forward extending right end 230 and forward extending left end 232 of the pivotal arm assembly 326. The rear ends of the forward extending right end 230 and left end 232 are connected to the rear cross member 328 via fasteners 231, or other suitable fasteners. The wider mounting flanges 327 at the opposed ends of the rear cross member 328 include a series of spaced apertures that align with apertures in mounting flanges 229 at the rear ends 230′, 232′ of forward extending ends 230, 232 on narrower or wider vehicles, permitting use of a rear cross member 328 of a single width, of one of a few widths. This connection advantageously enables the pivotal arm assembly 328 of the scarifier assembly 310 to be more easily and efficiently packaged and shipped. As noted above, alternative means of connection of the rear cross member to the right and left forward extending ends on vehicles having different widths alternatively may be accomplished using different mounting flange and fastener configurations.

The fourth example scarifier assembly 310 illustrates yet another different configuration by which teeth 233 and may be connected to a rear cross member 328. For example, each previously described elongated tooth 233, or tooth of a different construction, may be connected to the rear cross member 328 directly. Thus, the teeth 233 may, for example, be welded to the rear cross member 328, as may be seen in FIG. 12. With the teeth 233 connected to the rear cross member 328 in this way, the teeth 233 of the pivotal arm assembly 326 are removably connected to the scarifier assembly 310. It will be appreciated that the teeth may be connected to a rear cross member in still further ways, such as by connection to the front of the rear cross member by means of welding or use of one or more suitable fasteners, or by having the teeth extend through apertures in a rear cross member, with the teeth being connected by means of welding or use of one or more suitable fasteners.

As with the previous examples, the forward portion of the pivotal arm assembly 326 of the fourth example scarifier assembly 310 may be connected to a vehicle and operate in a similar manner to the previous example scarifier assemblies 10, 110 and 210. Thus, the forward extending right end 230 of the pivotal arm assembly 326 is pivotally connected to a right first pivot and the forward extending left end 232 of the pivotal arm assembly 326 is pivotally connected to a left first pivot. Accordingly, a right lift actuator is pivotally connected at a first end to a right second pivot and is pivotally connected at a second end to the forward extending right end 230 of the pivotal arm assembly 326 at a location spaced from the connection of the forward extending right end 230 of the pivotal arm assembly 326 to the right first pivot. Similarly, a left lift actuator is pivotally connected at a first end to the left second pivot and pivotally connected at a second end to the forward extending left end 232 of the pivotal arm assembly 326 at a location spaced from the connection of the forward extending left end 232 of the pivotal arm assembly 326 to the left first pivot. As noted, the pivots may be directly connected to a vehicle or may be connected via housing assemblies, as shown for the first example scarifier assembly 10.

From the above disclosure, it will be apparent that a scarifier assembly constructed in accordance with this disclosure may include a number of structural aspects that provide significant advantages over prior art scarifier assemblies for use on vehicles, depending upon the specific design chosen.

It will be appreciated that a scarifier assembly may be embodied in various configurations in accordance with the present disclosure. Any variety of suitable materials of construction, configurations, shapes and sizes for the components and methods of connecting the components may be utilized to meet the particular needs and requirements of an end user. It will be apparent to those skilled in the art that various modifications can be made in the design and construction of such a scarifier assembly without departing from the scope or spirit of the claimed subject matter, and that the claims are not limited to the preferred embodiment illustrated herein.

The status of the claims:

1. A scarifier assembly for connection to a vehicle, comprising:
a right first pivot located forward of and below a right second pivot, and a left first pivot located forward of and below a left second pivot;
a pivotal arm assembly comprising a rear cross member extending between and connected at a fixed angle relative to a forward extending right end and a forward extending left end;
a plurality of teeth connected to the rear cross member of the pivotal arm assembly;
the forward extending right end of the pivotal arm assembly being pivotally connected to the right first pivot and the forward extending left end of the pivotal arm assembly being pivotally connected to the left first pivot;
a right lift actuator pivotally connected at a first end to the right second pivot and pivotally connected at a second end to the forward extending right end of the pivotal arm assembly at a location along the forward extending right end and spaced from the connection of the forward extending right end of the pivotal arm assembly to the right first pivot;
a left lift actuator pivotally connected at a first end to the left second pivot and pivotally connected at a second end to the forward extending left end of the pivotal arm assembly at a location along the forward extending left end and spaced from the connection of the forward extending left end of the pivotal arm assembly to the left first pivot; and
wherein each of the right and left first and second pivots are located within respective right and left housing assemblies, and each of the right and left housing assemblies comprises an inner wall connected to the vehicle and an outer wall spaced outward from the inner wall, each respective right first pivot and second pivot extend between the respective inner wall and outer wall of the right housing assembly, and each respective left first pivot and second pivot extend between the respective inner wall and outer wall of the left housing assembly.

2. The scarifier assembly of claim 1, wherein the right and left actuators move the pivotal arm assembly to pivot about the right and left first pivots and between a first raised position and a second lowered position.

3. (canceled)

4. The scarifier assembly of claim 1, wherein each of the plurality of teeth further comprises a planar tooth body and a hardened tip portion.

5. The scarifier assembly of claim 1, wherein the lift actuators are hydraulic and are connected to a diverter valve.

6. (canceled)

7. (canceled)

8. The scarifier assembly of claim 1, wherein the outer wall of each of the right and left housing assemblies further comprises mounting apertures through which mounting fasteners are accessible.

9. The scarifier assembly of claim 1, wherein the outer wall of each of the right and left housing assemblies further comprises respective apertures through which the first pivot and second pivot are accessible.

10. The scarifier assembly of claim 9, wherein the outer wall of each of the right and left housing assemblies further comprises closure elements that extend over the respective apertures through which the first pivot and second pivot are accessible.

11. The scarifier assembly of claim 1, wherein the outer wall of each of the right and left housing assemblies further comprises a central opening through which the lift actuator is accessible and the outer wall of each of the right and left housing assemblies further comprises a removable cover that closes the respective central opening.

12. The scarifier assembly of claim 1, wherein the plurality of teeth is removably connected to the rear cross member.

13. The scarifier assembly of claim 12, wherein the rear cross member further comprises rearward extending flanges to which the plurality of teeth is removably connected.

14. The scarifier assembly of claim 12, wherein two or more of the plurality of teeth are connected to an elongated element that is removably connected to the rear cross member.

15. The scarifier assembly of claim 13, wherein each of the plurality of teeth further comprises a central body having at least one aperture, and each flange extending rearward from the rear cross member further comprises at least one aperture, and a fastener or elongated rod extends through the respective apertures.

16. The scarifier assembly of claim 15, wherein each of the plurality of teeth further comprises an upper end having an upward extending angle from the central body and a lower end having a downward extending angle from the central body, wherein the angle at which the upper end extends upward is the same as the angle at which the lower end extends downward.

17. The scarifier assembly of claim 16, wherein the orientation of each of the plurality of teeth is reversible end-to-end to present the same downward extending angle from the central body and may be rotated to reverse the downward extending angle from the central body.

18. The scarifier assembly of claim 1, wherein the rear cross member further comprises mounting flanges at respective opposed right and left ends and the rear end of the forward extending right end and rear end of the forward extending left end of the pivotal arm assembly each comprises a mounting flange, and wherein the mounting flanges at the opposed ends of the rear cross member are removably connected to mounting flanges at the respective rear ends of the forward extending right end and forward extending left end of the pivotal arm assembly.

19. The scarifier assembly of claim 18, wherein the flanges at the opposite ends of the rear cross member further comprise a plurality of mounting positions.

20. The scarifier assembly of claim 18, wherein each of the plurality of teeth is directly fixedly connected to the rear cross member.

21. A scarifier assembly for connection to a vehicle, comprising:
a right first pivot located forward of and below a right second pivot, and a left first pivot located forward of and below a left second pivot;
a pivotal arm assembly comprising a rear cross member extending between and connected at a fixed angle relative to a forward extending right end and a forward extending left end;
a plurality of teeth connected to the rear cross member of the pivotal arm assembly;
the forward extending right end of the pivotal arm assembly being pivotally connected to the right first pivot and the forward extending left end of the pivotal arm assembly being pivotally connected to the left first pivot;
a right lift actuator pivotally connected at a first end to the right second pivot and pivotally connected at a second end to the forward extending right end of the pivotal arm assembly at a location along the forward extending right end and spaced from the connection of the forward extending right end of the pivotal arm assembly to the right first pivot;
a left lift actuator pivotally connected at a first end to the left second pivot and pivotally connected at a second end to the forward extending left end of the pivotal arm assembly at a location along the forward extending left end and spaced from the connection of the forward extending left end of the pivotal arm assembly to the left first pivot; and
wherein each of the right and left first and second pivots are located within respective right and left housing assemblies, and each of the right and left housing assemblies comprises an inner wall connected to the vehicle and an outer wall spaced outward from the inner wall, wherein the outer wall of each of the right and left housing assemblies further comprises a central opening through which the lift actuator is accessible and the outer wall of each of the right and left housing assemblies further comprises a removable cover that closes the respective central opening.

22. The scarifier assembly of claim 21, wherein the plurality of teeth is removably connected to the rear cross member.

23. The scarifier assembly of claim 21, wherein each of the plurality of teeth is directly fixedly connected to the rear cross member.
